(19) United States
(12) Patent Application Publication
(10) Pub. No.: US 2011/0035537 A1
(43) Pub. Date: Feb. 10, 2011

(54) MULTIPROCESSOR SYSTEM HAVING MULTI-COMMAND SET OPERATION AND PRIORITY COMMAND OPERATION

(75) Inventor: Jin-Hyoung KWON, Seongnam-si (KR)

Correspondence Address: VOLENTINE & WHITT PLLC, ONE FREEDOM SQUARE, 11951 FREEDOM DRIVE SUITE 1260, RESTON, VA, 20190, US

(73) Assignee: SAMSUNG ELECTRONICS CO., LTD., Suwon-si (KR)

(21) Appl. No.: 12/775,748

(22) Filed: May 7, 2010

(30) Foreign Application Priority Data
Aug. 4, 2009 (KR) 10-2009-0071549

(51) Int. Cl. G06F 12/02; G06F 12/00

(52) U.S. Cl. 711/103; 711/149; 711/E12.008; 711/E12.001

(57) ABSTRACT

A multiprocessor system comprises a multi-port semiconductor memory device, a first processor, and a memory link architecture. The multi-port semiconductor memory device comprises a mailbox area and a shared memory area accessible through a plurality of ports. The first processor is configured to write a multi-command set comprising multiple commands for multiple read/write operations to a command area of the shared memory, and to write a message to the mailbox area to indicate the writing of the multi-command set. The memory link architecture comprises a second processor connected to the multi-port semiconductor memory device, and a nonvolatile semiconductor memory device connected to the second processor. The second processor is configured to read the multi-command set from the mailbox area and to sequentially perform the multiple read/write operations according to the multi-command set.

### CROSS-REFERENCE TO RELATED APPLICATIONS

This application claims priority under 35 U.S.C. §119 to Korean Patent Application No. 10-2009-0071549 filed on Aug. 4, 2009, the disclosure of which is hereby incorporated by reference in its entirety.

### BACKGROUND

Embodiments of the inventive concept relate generally to multiprocessor systems. More particularly, embodiments of the inventive concept relate to multiprocessor systems having memory link architectures.

A number of modern consumer electronic systems incorporate multiple processors in an effort to enhance performance. Examples of such systems include portable media players, smart phones, global positioning systems, digital cameras, digital video cameras, and a personal digital assistants, to name but a few.

In many of these systems, the different processors are used to perform different functions. For instance, in modern smart phones, one processor can be used to process baseband communications, another processor can be used to process multimedia data, another processor can be used to run operating system code, and so on.

In most multiprocessor systems, each processor is connected to a separate memory, such as a dynamic random access memory (DRAM) or a static random access memory (SRAM). Each of these memories typically has enough access ports to allow data exchange between the corresponding processor and external devices such as a host. These ports, however, are generally used for communication with only one processor.

Some newer multi-port semiconductor memory devices allow simultaneous communication with multiple processors. For instance, OneDRAM™, made by Samsung, is a fusion memory chip capable of increasing a data processing speed between two processors such as a communication processor and a media processor in a mobile device. OneDRAM™ routes data between the processors through a single chip and can substantially reduce the amount of time taken to transmit data between processors using a dual-port approach. In high-performance portable devices, such as advanced smart phones and multimedia rich-handsets, a single OneDRAM™ module can be substituted for two mobile memory chips.

A multiprocessor system comprising a multi-port semiconductor memory device such as OneDRAM can incorporate a memory link architecture in which a processor is linked to the multi-port semiconductor memory device and a flash memory. In one example of such a memory link architecture, the processor comprises an application specific integrated circuit (ASIC) processor that receives commands from a host processor through the multi-port semiconductor memory device and performs memory access operations on the flash memory in response to the commands.

In many memory link architectures, the ASIC processor receives and executes one command at a time, which can lead to inefficient read/write performance and power consumption. For instance, in some of these memory link architectures, the receipt of a single command requires the ASIC wake up from a sleep mode, which tends to increase power consumption. Additionally, frequent single-command interrupts can also add to timing overhead, further degrading the performance of read/write operations. Finally, the ASIC may experience complications in prioritizing certain operations, which can lead to inadequate response time or completion for urgent or instant operations received while other operations are being performed.

### SUMMARY

Selected embodiments of the inventive concept provide multiprocessor systems and related methods of operation. Some of the embodiments reduce timing overhead by reducing the number of times a sub processor is woken up. Some embodiments improve the performance of read/write operations of a processor by transmitting a set of multiple commands (a “multi-command set”) to a processor in a single data transfer. Some embodiments provide multiprocessor systems having a memory link architecture in which a host processor writes a multi-command set in a shared memory area and a sub processor sequentially performs multiple read/write operations according to the multi-command set. Some embodiments provide multiprocessor systems capable of performing multiple read/write operations according to a multi-command set to reduce or minimize power consumption. Some embodiments provide multiprocessor systems capable of interrupting execution of a multi-command set to read or write urgent data or important data on a priority basis. Some embodiments provide multiprocessor systems capable of processing instant commands, such as those received while a multi-command set is being executed, on a priority basis.

According to one embodiment of the inventive concept, a multiprocessor system comprises a multi-port semiconductor memory device, a first processor, and a memory link architecture. The multi-port semiconductor memory device comprises a mailbox area and a shared memory area accessible through a plurality of ports. The first processor is configured to write a multi-command set comprising multiple commands for multiple read/write operations to a command area of the shared memory, and to write a message to the mailbox area to indicate the writing of the multi-command set. The memory link architecture comprises a second processor connected to the multi-port semiconductor memory device, and a nonvolatile semiconductor memory device connected to the second processor. The second processor is configured to read the multi-command set from the mailbox area and to sequentially perform the multiple read/write operations according to the multi-command set.

In certain embodiments, the nonvolatile semiconductor memory device is connected to the multi-port semiconductor memory device through the second processor and comprises a flash memory for storing data written in the shared memory area by the first processor.

In certain embodiments, each of the multiple commands comprises a command type, an address in the shared memory area, an address in the flash memory, and a sector counter.

In certain embodiments, the message written to the mailbox area comprises a command type, a function code, and a function parameter.

In certain embodiments, the first processor comprises a host processor and the second processor comprises an application specific integrated circuit (ASIC) processor.

In certain embodiments, the second processor performs an instant operation between execution of two of the multiple read/write operations in response to an instant command received during execution of one of the multiple read/write operations.

In certain embodiments, the instant command is stored in the shared memory area.

In certain embodiments, after completing the instant data process operation, the second processor continues performing the remaining read/write operations of the multiple read/write operations.

In certain embodiments, the multi-port semiconductor memory device comprises a OneDRAM.

In certain embodiments, the multi-port semiconductor memory device further comprises a semaphore area configured to store information for controlling access to the shared memory area.

According to another embodiment of the inventive concept, a multiprocessor system comprises a multi-port semiconductor memory device, a first processor, a second processor, and a nonvolatile memory device. The multi-port semiconductor memory device comprises dedicated memory areas and a shared memory area accessible through a plurality of ports, first and second mailbox areas configured to facilitate inter-processor communication, and a semaphore area configured to store information for controlling access to the shared memory area. The first processor is connected to a first port of the multi-port semiconductor memory device and is configured to access a nonvolatile semiconductor memory device through the multi-port semiconductor memory device, to write a multi-command set or an instant command to a command area of the shared memory area, and to write a multi-command write message or an instant operation message to the second mailbox area. The second processor is connected to a second port of the multi-port semiconductor memory device and to the nonvolatile semiconductor memory device to form a memory link architecture, and configured to read the multi-command set from the second mailbox area, to sequentially perform multiple read/write operations according to the multi-command set, and to perform an instant operation according to the instant command between two of the multiple read/write operations. The nonvolatile semiconductor memory device is configured to store data from the first and second processors.

In certain embodiments, after the second processor completes the instant operation, it continues to perform remaining read/write operations among the multiple read/write operations.

In certain embodiments, after the second processor completes the instant operation, it writes a process completion message to the first mailbox area.

In certain embodiments, the multi-command write message comprises a command type, a function code, and a function parameter.

In certain embodiments, the nonvolatile semiconductor device comprises a phase change random access memory (PRAM).

In certain embodiments, the second processor comprises a media processor such as a graphics processor or audio processor or a combination thereof

According to still another embodiment of the inventive concept, a method of operating a multiprocessor system is provided. The multiprocessor system comprises first and second processors, a multi-port semiconductor memory device connected to the first and second processors and comprising a shared memory area comprising a mailbox area and a command area, and a nonvolatile memory device connected to the second processor. The method comprises transmitting a multi-command set comprising multiple read/write commands from the first processor to the command area of shared memory area in the multi-port semiconductor memory device, storing message data in the mailbox area to indicate the presence of the multi-command set in the command area, detecting the message data in the mailbox area, and as a consequence of detecting the message data in the mailbox area, accessing the multi-command set in the command area and operating the second processor to execute multiple read/write operations corresponding to the multiple read/write commands.

In certain embodiments, the method further comprises receiving an instant command in the shared memory during execution of one of the multiple read/write operations, and storing an instant command message in the shared memory area to indicate the presence of the instant command, detecting the instant command stored in the shared memory based on the stored instant command message; and operating the second processor to execute an operation defined by the instant command between execution of two of the multiple read/write operations.

In certain embodiments, the first processor comprises a host processor and the second processor comprises an ASIC processor.

In certain embodiments, the nonvolatile memory comprises a NOR flash memory.

### BRIEF DESCRIPTION OF THE DRAWINGS

Embodiments of the inventive concept are described below with reference to the accompanying drawings. In the drawings, like reference numbers denote like features. The drawings are not necessarily to scale, emphasis instead being placed upon illustrating aspects of the inventive concept.

FIG. 1 is a block diagram illustrating a multiprocessor system according to an embodiment of the inventive concept.

FIG. 2 is a memory diagram illustrating an arrangement of data stored in a shared memory area of a multi-port semiconductor memory device shown in FIG. 1.

FIG. 3 is a diagram illustrating example command formats for commands illustrated in FIG. 2.

FIG. 4 is a drawing illustrating a message format of mailbox areas illustrated in FIG. 1.

FIG. 5 is a drawing illustrating an example of a four-byte message using the message format of FIG. 4.

FIG. 6 is a diagram illustrating an example of a multi-command set stored in a command area of FIG. 2.

FIG. 7 is a timing diagram illustrating the execution of multiple read/write operations according to an embodiment of the inventive concept.

FIGS. 8 and 9 are flowcharts illustrating methods of operating the multiprocessor system of FIG. 1.

### DETAILED DESCRIPTION OF THE EMBODIMENTS

Embodiments of the inventive concept are described more fully hereinafter with reference to the accompanying drawings. The inventive concept may be embodied in many different forms and should not be construed as limited to the embodiments set forth herein. Rather these embodiments are provided as teaching examples for illustrating various aspects of the inventive concept.

Unless otherwise defined, all terms (including technical and scientific terms) used herein have the same meaning as commonly understood in the art to which the inventive concept pertains. It will be further understood that terms used herein should be interpreted as having a meaning that is consistent with their meaning in the context of this specification and the relevant art and will not be interpreted in an idealized or overly formal sense unless expressly so defined herein.

It will be understood that, although the terms first, second, etc. are to be used herein to describe various elements, these elements should not be limited by these terms. Rather, these terms are used to distinguish one element from another, but not to imply a required sequence of elements. For example, a first element can be termed a second element, and, similarly, a second element can be termed a first element, without departing from the scope of the inventive concept. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the inventive concept. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

Spatially relative terms, such as “beneath,” “below,” “lower,” “above,” “upper” and the like may be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as “below” and/or “beneath” other elements or features would then be oriented “above” the other elements or features. The device may be otherwise oriented (e.g., rotated 90 degrees or at other orientations) and the spatially relative descriptors used herein interpreted accordingly.

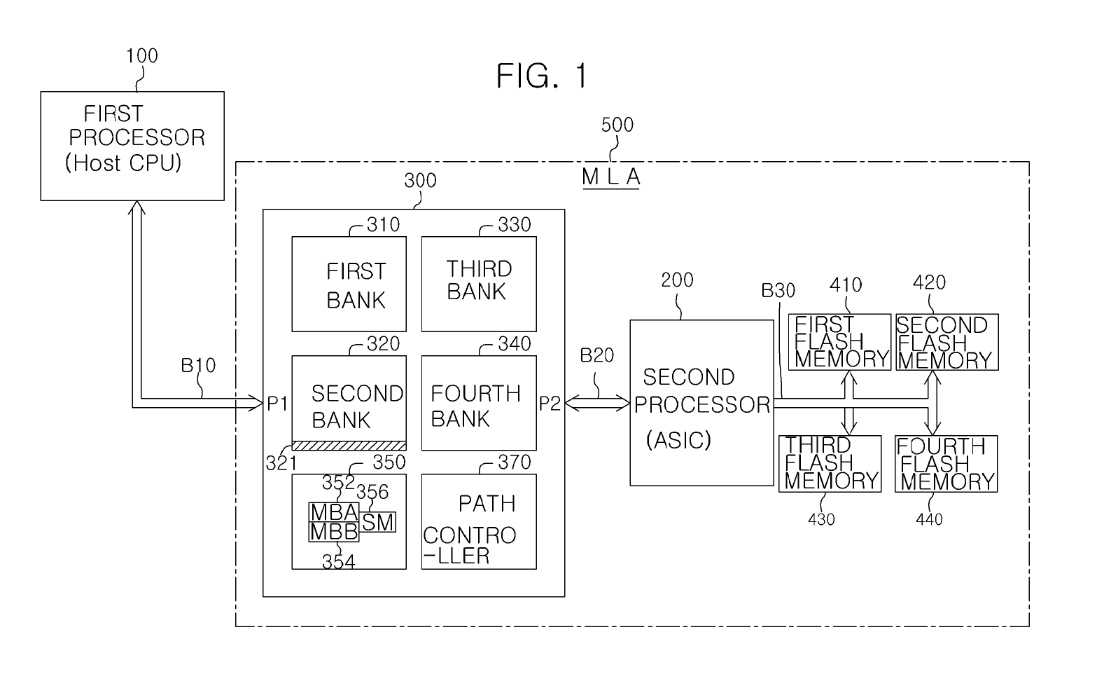

FIG. 1 is a block diagram illustrating a multiprocessor system according to an embodiment of the inventive concept.

Referring to FIG. 1, a multiprocessor system such as a mobile device comprises a first processor 100 acting as a host processor, a second processor 200 acting as a sub processor, a multi-port semiconductor memory device 300 such as a OneDRAM acting as a main memory for first and second processors 100 and 200, and a plurality of flash memories 410, 420, 430, and 440 providing nonvolatile data storage for first and second processors 100 and 200. Collectively, second processor 200, multi-port semiconductor memory device 300, and flash memories 410, 420, 430, and 440 form a memory link architecture (MLA) 500.

In the embodiment of FIG. 1, first processor 100 comprises a general purpose processor used to perform a variety of functions, and second processor 200 comprises an ASIC for performing specific functions such as processing communication data or multimedia data. In other embodiments, first and second processors 100 and 200 can be modified to perform additional or alternative functions. In other words, processors 100 and 200 are not limited to specific types described herein.

First processor 100 is connected to multi-port semiconductor memory device 300 through a system bus B10 and second processor 200 is connected to multi-port semiconductor memory device 300 through a system bus B20 such that first and second processors 100 and 200 share multi-port semiconductor memory device 300. As a result, the cost and size of the multiprocessor system can be reduced.

Flash memories 410, 420, 430, and 440 are connected to second processor 200 through a system bus B30 such that first processor 100 can indirectly access flash memories 410, 420, 430, and 440 through multi-port semiconductor memory device 300 and second processor 200. Meanwhile, second processor 200 can directly access the plurality of flash memories 410, 420, 430, and 440.

Flash memories 410, 420, 430, and 440 typically comprise NOR-type flash memories or NAND-type flash memories. These flash memories can be used to store data requiring nonvolatile storage, such as communication data, programs, or boot codes of a mobile device. The flash memories are not, however, limited to storing certain types of data. By allowing first processor 100 to be indirectly connected to flash memories 410, 420, 430, and 440, the cost and size of the multiprocessor system can be reduced.

Multi-port semiconductor memory device 300 comprises multiple ports P1 and P2, a plurality of memory banks 310, 320, 330, and 340, an internal register 350, and a path controller 370.

First port P1 is connected to first processor 100 via system bus B10, and second port P2 is connected to second processor 200 via system bus B20. Accordingly, first and second processors 100 and 200 access memory banks of multi-port semiconductor memory device 300 through two different access paths.

First bank 310 is dedicated to first processor 100, third and fourth banks 330 and 340 are dedicated to second processor 200, and second bank 320 is shared by first and second processors 100 and 200 through first and second ports P1 and P2. In other words, within multi-port semiconductor memory device 300, second bank 320 is accessed by first and second processors 100 and 200, third and fourth banks 330 and 340 are accessed only by second processor 200, and first bank 310 is accessed only by first processor 100.

Path controller 370 coordinates shared access to second bank 320. For instance, path controller 370 connects second bank 320 to system bus B10 via first port P1 to allow access by first processor 100, and connects second bank 320 to system bus B20 via second port P2 to allow access by second processor 200. While first processor 100 accesses second bank 320, second processor 200 can access third bank 330 or fourth bank 340, and while first processor 100 does not access second bank 320, second processor 200 can access second bank 320. Similarly, while second processor 200 accesses second bank 320, first processor 100 can access first bank 310, and while second processor 200 does not access second bank 320, first processor 100 can access second bank 320.

First, second, third and fourth memory banks 310, 320, 330 and 340 typically comprise DRAM cells. Memory banks 310, 320, 330, and 340 each typically comprise one or more memory areas. Each memory bank can have a storage capacity of, for example, 16 Mb (Megabit), 32 Mb, 64 Mb, 128 Mb, 256 Mb, 512 Mb, or 1024 Mb.

Internal register 350 comprises a data storage area storing path control information of path controller 370 and providing an interface between first and second processors 100 and 200. Internal register 350 can be accessed by the first and second processors 100 and 200 and typically comprise a latch circuit such as a flip-flop circuit. Internal register 350 can also be formed of latch-type memory cells, such as SRAM cells.

In the embodiment of FIG. 1, internal register 350 comprises a first mailbox area 352, a second mailbox area 354, and a semaphore area 356. Semaphore area 356 stores information used to control access to the shared memory area. First and second mailbox areas 352 and 354 store messages received from first and second processors 100 and 200. The stored messages are communicated between first and second processor 100 and 200 through the first and second mailbox areas 352 and 354. Each message can include, for instance, an access request for second memory bank 320, an address, transmission data indicating an address of second memory bank 320 where data is stored, the size of data, and/or commands.

Messages transmitted from second processor 200 to first processor 100 are typically stored in first mailbox area 352, and messages transmitted from first processor 100 to second processor 200 are typically written in second mailbox area 354. Semaphore area 356 typically stores one or more bits, and first and second mailbox areas 352 and 354 typically store 4 or more bytes.

To communicate with second processor 200, first processor 100 writes a message in second mailbox area 354. Second processor 200 detects and reads the message and can perform an operation in response to the message. Second processor 200 can communicate with first processor 100 in a similar manner by writing messages in first mailbox area 352.

In one type of communication, second processor 200 transfers access authority for second bank 320 to first processor 100 by changing a flag data of semaphore area 356 within internal register 350 and then writing a message in first mailbox area 352 to indicate the transfer of access authority. First processor 100 reads the message from first mailbox 352 and confirms that the flag data of semaphore area 356 has been changed. After confirming the change of the flag data, first processor 100 writes a response message in second mailbox area 354 informing second processor 200 of the receipt of the access authority. Then, first processor 100 has the access authority for the shared memory area 320 until an authority request is granted to second processor 200 or a task of first processor 100 is completed.

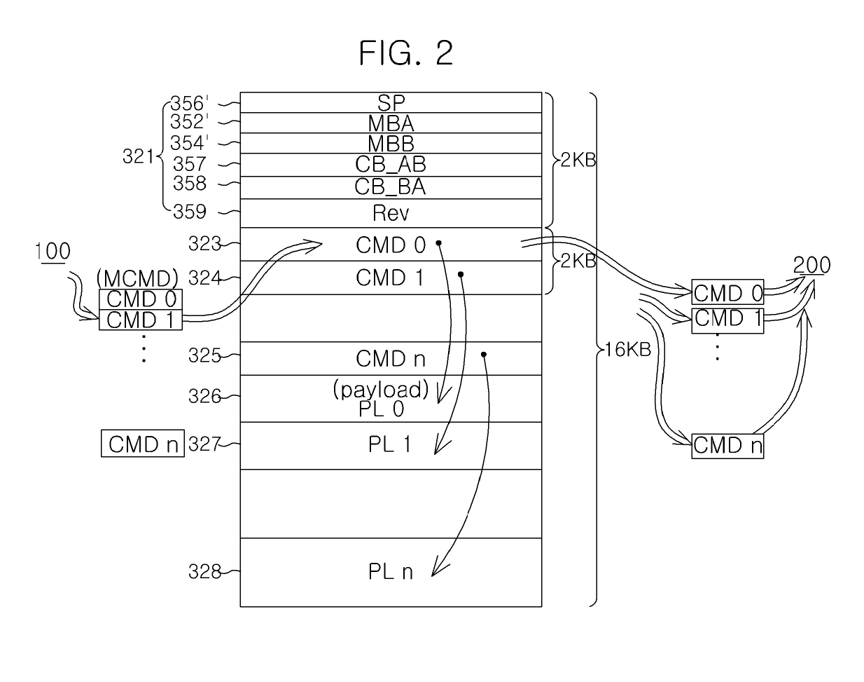

In the example of FIG. 1, a specific area 321 of second bank 320 is designated as a reserved or disabled area for internal register 350. Specific area 321 can be assigned a row address (e.g., 0x7FFFFFFFh˜0x8FFFFFFFh, 2 KB size=1 row size), and the row address can be used to select portions of internal register 350, as will be described below in relation to FIG. 2.

FIG. 2 is a memory diagram illustrating an arrangement of data stored in a shared memory area within second bank 320 of multi-port semiconductor memory device 300 shown in FIG. 1.

Referring to FIG. 2, specific area 321 of second bank 320 comprises a semaphore area 356′ corresponding to semaphore area 356 of internal register 350, first and second mailbox areas 352′ and 354′ corresponding to respective first and second mailbox areas 352 and 354 of internal register 350, check bit areas 357 and 358, and a reserved area 359. Where an address is provided to select first mailbox area 352′ of specific area 321, first mailbox area 352 of internal register 350 of FIG. 1 is selected instead of first mailbox area 352′ of specific area 321. Consequently, specific area 321 of second bank 320 is a disabled area.

In the embodiment of FIG. 2, second bank 320 comprises command areas 323, 324, and 325 where command data is written, and payload areas 326, 327, and 328 where payloads are written. Where command area 323 receives a write command from first processor 100 to perform a write operation on one of the flash memories in MLA 500, corresponding write data is stored in payload area 326, which corresponds to command area 323. Where command area 324 receives a write command from first processor 100 to perform a write operation on one of the flash memories in MLA 500, corresponding write data is stored in payload area 327, which corresponds to command area 324.

In the embodiment of FIG. 2, first processor 100 can write a multi-command set to one or more of command areas 323, 324, and 325. Consequently, first processor 100 can write a multi-command set defining multiple read and/or write commands (also referred to as read/write commands) to the shared memory area and second processor 200 can sequentially execute multiple data read and/or write operations according to the multi-command set, resulting in a reduction in the number of times the access authority for the shared memory area is transferred.

Second processor 200 can be required to wake up and obtain access authority for second bank 320 each time first processor 100 provides it with a command. Accordingly, to reduce the relative amount of overhead produced by the wake up and access authority operations, first processor 100 can write a multi-command set comprising multiple commands to command area 323 and inform second processor 200 through second mailbox area 354 that the multi-command set has been written. By reducing the relative amount of overhead power consumption and performance of the multiprocessor system can be improved.

First processor 100 writes a multi-command set (MCMD) comprising multiple commands for multiple read and/or write operations (also referred to as read/write operations) to command area 323 and informs second processor 200 of the multi-command set through second mailbox area 354. Thereafter, second processor 200 reads the message from second mailbox area 354, detects the presence of the multi-command set, and sequentially performs the multiple read and/or write operations according to the multi-command set stored in command area 323.

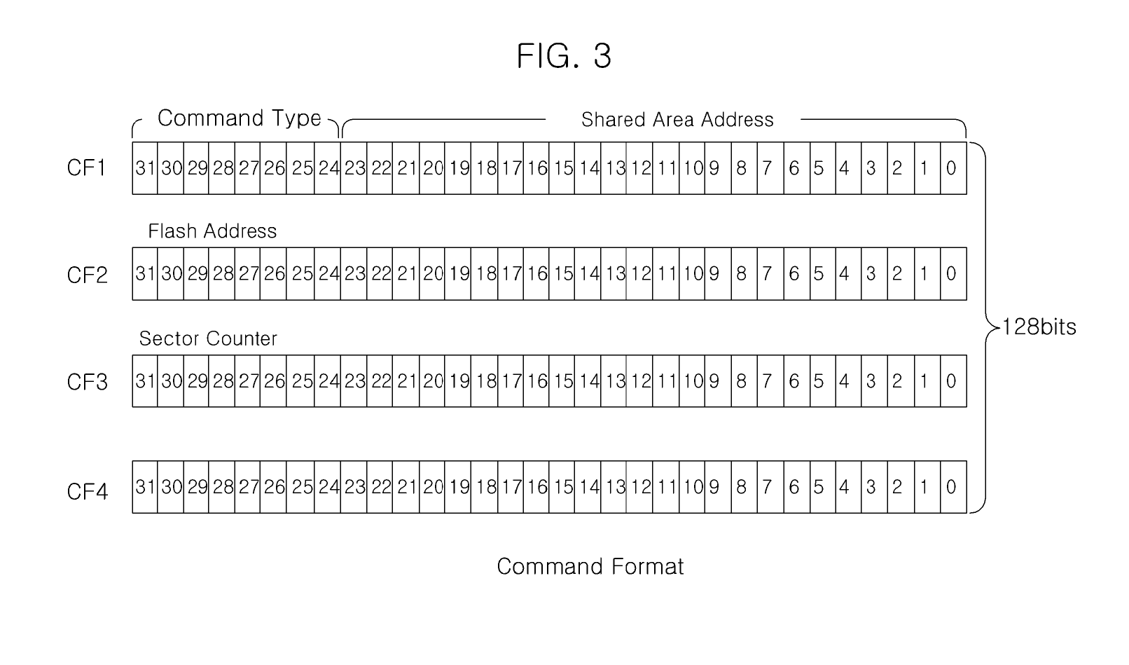

FIG. 3 is a diagram illustrating example command formats for single commands illustrated in FIG. 2.

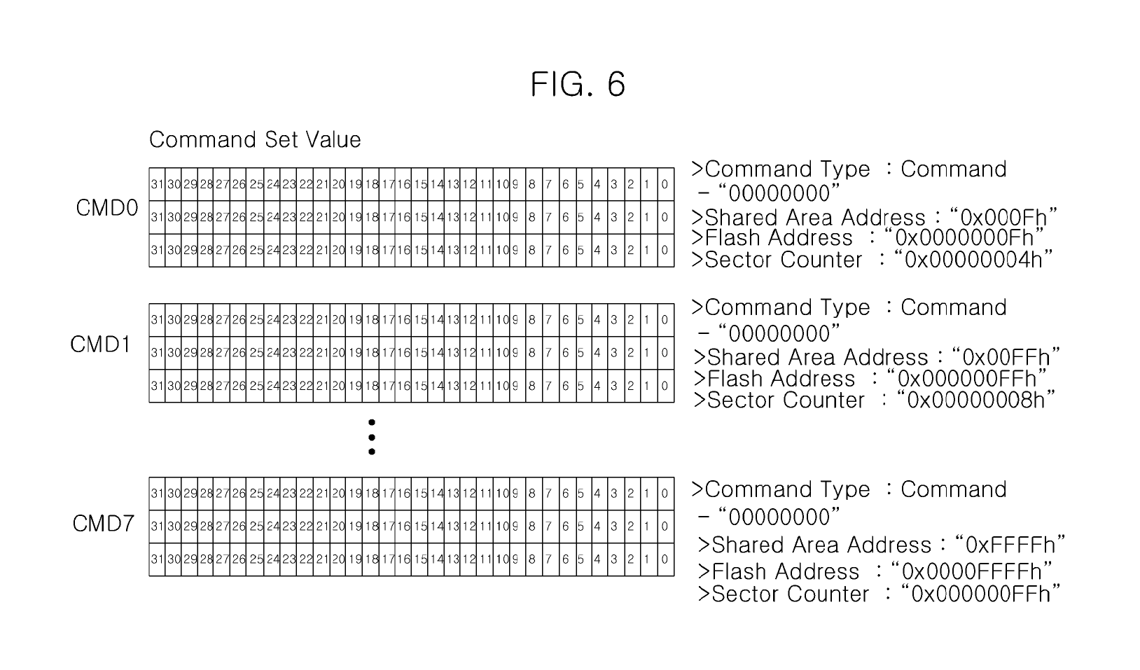

Referring to FIG. 3, a single command format comprises 128 bits and first through fourth command format frames CF1 to CF4 having 32 bits each. First command format frame CF1 comprises a command type area for indicating a command type and a shared memory area address area for indicating an address of the shared memory area. The command type area comprises 8 bits and the shared memory area address area comprises 24 bits. Second command format frame CF2 comprises a flash memory address area for indicating an address of a flash memory. Third and fourth command format frames CF3 and CF4 comprise a sector counter area for indicating a sector counter. Specific examples of data written in the command format are shown in FIG. 6.

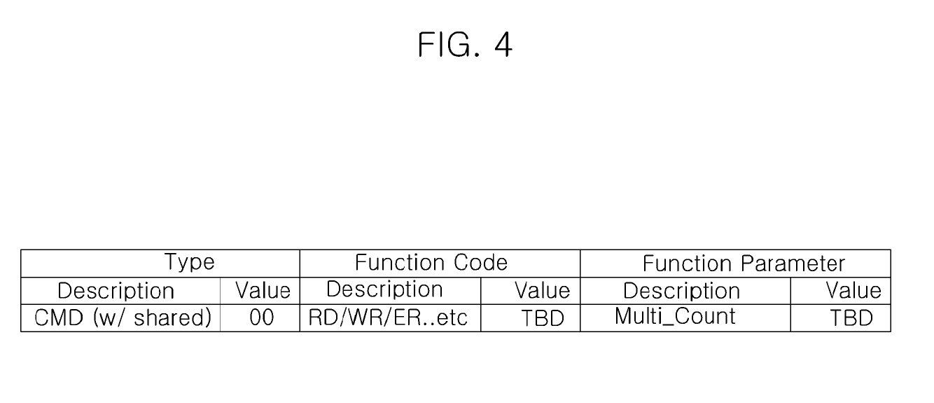

FIG. 4 is a drawing illustrating a message format of mailbox areas illustrated in FIG. 1.

The message format comprises a type area, a function code area, and a function parameter area. For example, in this embodiment, a value ‘00’ stored in the type area indicates a command. A code indicating a read or write or erase operation is stored in the function code area. The label ‘TBD’ in FIG. 4 indicates that a corresponding value is defined before testing.

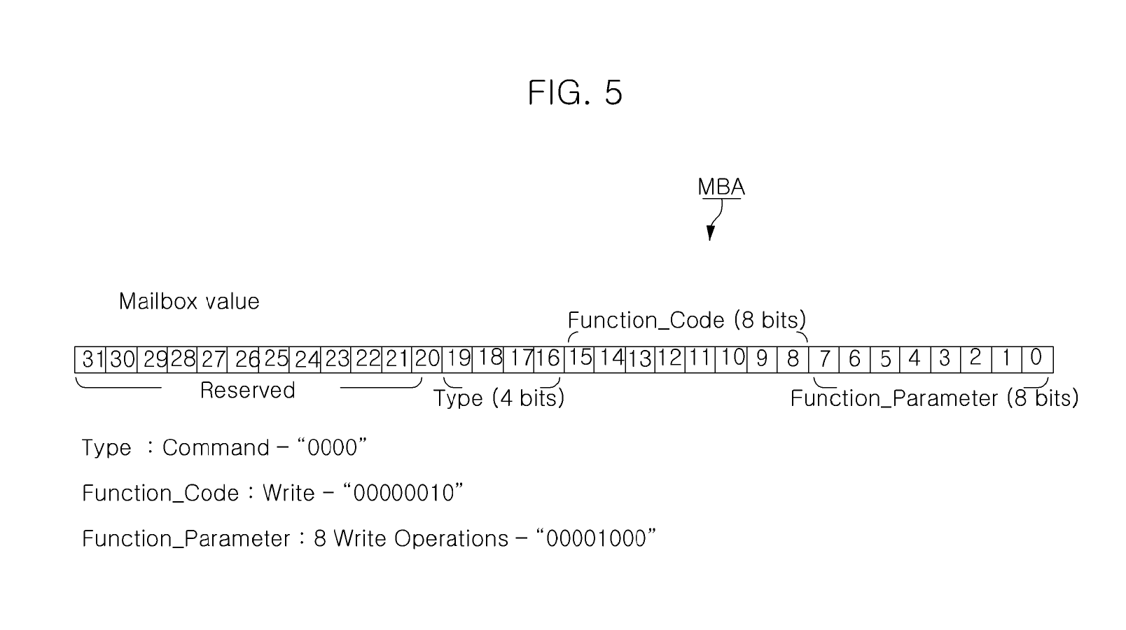

FIG. 5 is a drawing illustrating an example of a four-byte message using the message format of FIG. 4. In this example, the type area comprises 4 bits, the function code area comprises 8 bits, and the function parameter area comprises 8 bits. A value ‘0000’ written in the type area of the mailbox indicates a command type, a value ‘00000010’ written in the function code area indicates a write operation, and a value ‘00001000’ written in the function parameter area indicates that the number of times a write operation will be performed is 8.

FIG. 6 is a diagram illustrating an example of a multi-command set stored in a command area of FIG. 2.

In this example, a command CMD0 has a command type ‘00000000’, an address of the shared memory area is ‘0x000Fh’, an address of a flash memory area is ‘0x0000000Fh’, and a sector counter is ‘0x00000004h’.

Referring to FIG. 1, where multiple commands are used to initiate multiple read/write operations, first processor 100 writes the multiple commands as a multi-command set to command area 323 of second bank 320 in a continuous data transfer operation and then writes a multi-command write message into second mailbox area 354 as shown FIG. 5. First processor 100 then transfers access authority for second bank 320 to second processor 200 by changing flag data in semaphore area 356 of internal register 350.

Where the flag data in semaphore area 356 is changed, second processor 200 has the access authority for second bank 320 of multi-port semiconductor memory device 300. Second processor 200 reads from second mailbox area 354 the message having the format shown in FIG. 5 and detects reception of the multi-command set. Then, second processor 200 having the access authority for second bank 320 sequentially performs the multiple read and/or write operations according to the multi-command set stored in command area 323.

Consequently, upon waking up, second processor 200 has access authority for second bank 320 and is able to sequentially perform the multiple read/write operations according to the multi-command set. As a result, timing overhead caused by frequent interrupts is reduced, read/write performance is improved, wake-up time of processor 200 is reduced, and power consumption of the system is reduced.

During the multiple read and/or write operations, it may be necessary to immediately process other data or commands on a priority basis. Accordingly, it is possible that the multiple read and/or write operations will be interrupted to perform the priority processing. A command that is processed on a priority basis between execution of different commands of a multi-command set will be referred to as an instant command.

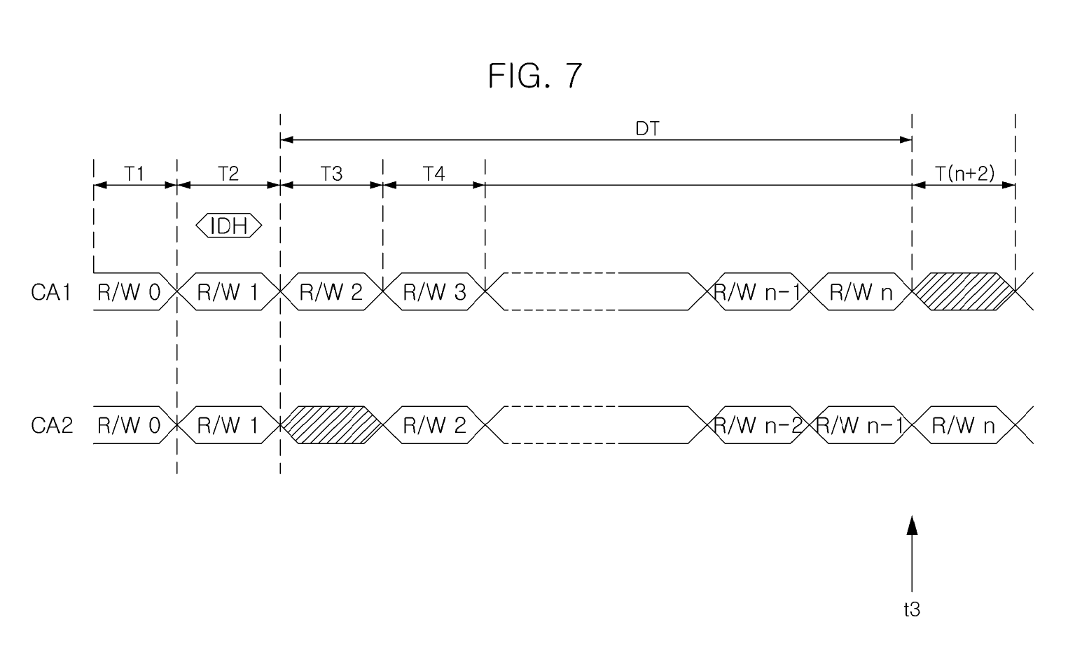

FIG. 7 is a timing diagram illustrating the execution of multiple read/write operations according to an embodiment of the inventive concept. In particular, FIG. 7 illustrates a first case CA1 and a second case CA2 in which another read/write operation IDH is requested through a read/write message IDH in a mailbox area. Second case CA2 is an embodiment where the multiple read/write operations are interrupted to perform the read/write operation IDH.

As indicated by second case CA2, a read/write message for operation IDH is detected in second mailbox area 354 in a period T2 during execution of a read/write operation in a multi-command set. Second processor 200 completes a current read/write operation in period T2 and then performs read/write operation IDH according to a corresponding command stored in second bank 320.

Where read/write operation IDH is requested through a corresponding message in second mailbox area 354 during period T2 of FIG. 7, second processor 200 completes a current read/write operation and performs read/write operation IDH in a period T3. Thereafter, second processor 200 performs the remaining read/write operations of the multiple read/write operations in a period T4 and subsequent periods. Therefore, it is possible to ensure adequate completion time for timing sensitive operations.

Where read/write operation IDH is performed after a period DT, the completion time may be too late. For instance, the data produced by read/write operation IDH may be stale or inaccurate after period DT. Accordingly, case CA1, where read/write operation IDH is not executed until after period DT, may result in errors.

In the embodiment of FIG. 7, where an instant read/write message is received or detected during the multiple read/write operations, an instant read/write operation such as read/write operation IDH is performed in accordance with an instant command stored in second bank 320 after a current read/write operation is completed. After the instant read/write operation is completed, second processor 200 performs the remaining read/write operations of the multiple read/write operations.

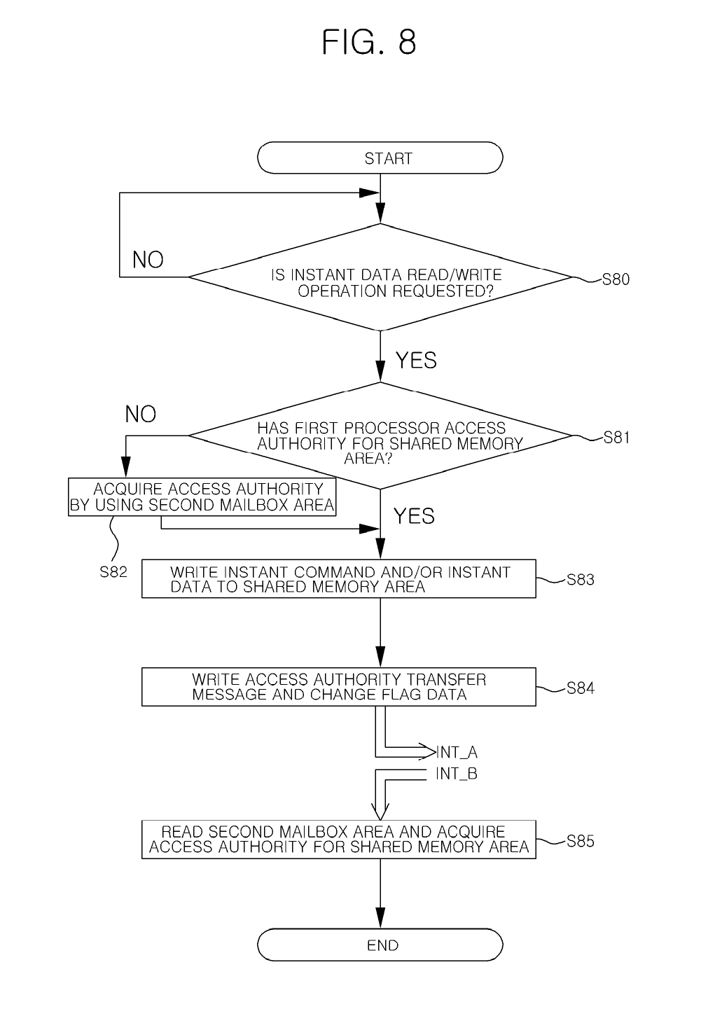

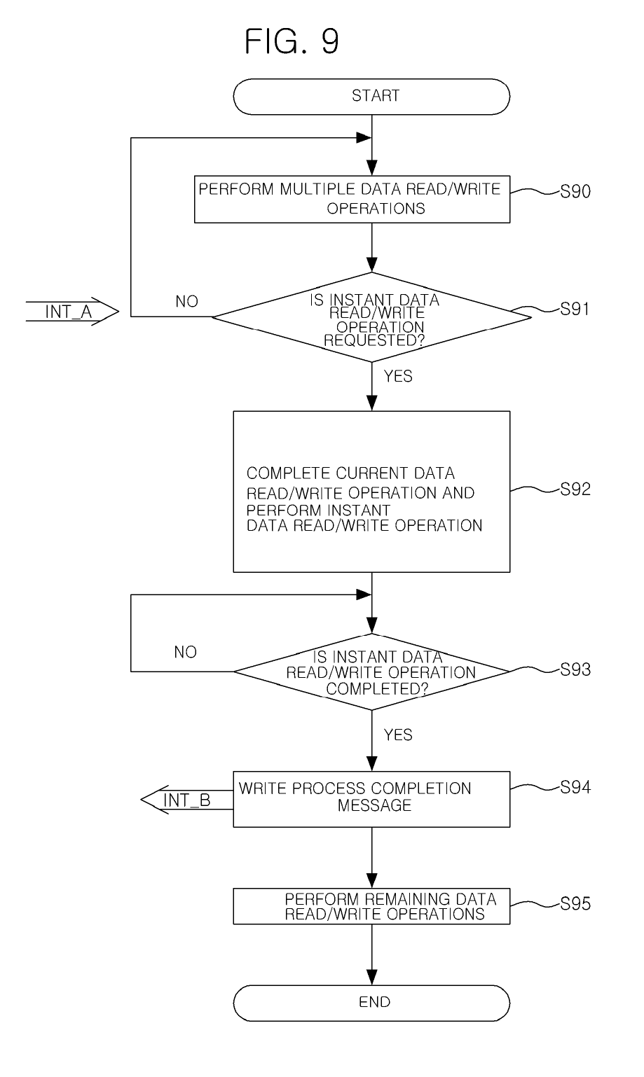

FIGS. 8 and 9 are flowcharts illustrating methods of operating the multiprocessor system of FIG. 1. In particular, FIG. 8 illustrates the operation of first processor 100 and FIG. 9 illustrates the operation of second processor 200. In the description of these methods, example methods steps are denoted by parentheses (SXX) to distinguish them from example system or device elements.

Referring to FIG. 8, first processor 100 determines whether an instant read/write operation is requested (S80). Where an instant read/write operation is requested, first processor 100 checks semaphore area 356 to determine whether first processor 100 has access authority for second bank 320 of multi-port semiconductor memory device 300 (S81). Where first processor 100 does not have access authority (S81=No), first processor 100 acquires the access authority by making a request using second mailbox area 354 (S82).

Where the requested instant read/write operation is a read operation, first processor 100 having the access authority for second bank 320 writes an instant command to the shared memory area (S83). Where the request instant read/write operation is a write operation, first processor 100 writes instant data to be stored in a flash memory into second bank 320 (S83). Thereafter, first processor 100 writes an access authority transfer message to second mailbox area 354 and changes the flag data of semaphore area 356 from ‘1’ to ‘0’ (S84). Then, first processor 100 generates an interrupt INT_A to be applied to second processor 200 to request execution of the instant read/write operation. The generation of interrupt INT_A changes the flow to FIG. 9, which illustrates the operation of second processor 200.

In the method of FIG. 9, second processor 200 starts the multiple read/write operations before receiving the interrupt INT_A (S90). An instant read/write operation can be requested while second processor 200 is performing the multiple read/write operations, as in the example of FIG. 7, where an instant read/write operation is requested in period T2. To ensure adequate completion time for the instant read/write operation, second processor 200 performs the instant read/write operation after a current operation. To accomplish this, second processor 200 reads the second mailbox area to determine whether an instant read/write operation is requested (S91).

Where an instant read/write operation is requested, second processor 200 completes a current read/write operation of the multiple read/write operations and performs the instant read/write operation according to an instant command stored in second bank 320 (S92). Where the instant command is a read command, second processor 200 writes data stored in a predetermined area of a flash memory to a predetermined area of the shared memory area. Where the instant command is a write command, write data stored in a predetermined area of the shared memory area is stored in a predetermined area of a flash memory (e.g., NAND flash memory). Where the instant read/write operation is requested in period T2, second processor 200 performs the instant read/write operation in period T3.

Second processor 200 next determines whether the instant read/write operation is completed (S93). Upon completion of the instant read/write operation, second processor 200 writes a process completion message to first mailbox area 352 (S94). Where the instant command is a read command, second processor 200 writes an access authority transfer message to the first mailbox area 352 and changes the flag data of semaphore area 356 from ‘1’ to ‘0’.

Thereafter, second processor 200 generates an interrupt INT_B to be applied to first processor 100. Interrupt INT_B informs first processor 100 of the completion of the instant read/write operation.

Referring to FIG. 8, upon receiving the interrupt INT_B, first processor 100 reads first mailbox area 352 (S85). Where the instant command is a read command, first processor 100 acquires access authority for second bank 320 and reads instant data. Consequently, first processor 100 can promptly receive important data stored in a flash memory even where second processor 200 is performing multiple read/write operations.

Referring to FIG. 9, after completing the instant read/write operation, second processor 200 continues with performing the multiple read/write operations (S95). For example, in second case CA2 of FIG. 7, second processor 200 performs the remaining read/write operations R/W2 through R/Wn.

In the embodiment of FIGS. 8 and 9, urgent or important data is instantly processed, which prevents the reliability of the urgent or important data from being degraded.

Although the above-described embodiments include multiprocessor systems comprising two processors, the inventive concept is not limited to any particular number of processors, nor is the inventive concept limited to any special combination of processors or processor types. The processors in various embodiments can comprise, for instance, microprocessors, CPUs, digital signal processors, micro controllers, reduced-instruction set computers, complex instruction set computer, or any of several other types of processors.

The above embodiments can be modified in a variety of ways in addition to those presented above. For instance, the configuration of control circuits or internal connections can be modified, replaced, or otherwise changed. The structure of the memory link architecture, the format of the multi-command set, and an instant data processing scheme can also be changed. Moreover, path controller 370 can be implemented in various alternative ways, and internal register 350 can be implemented in ways other than the mailbox areas and semaphore area. The nonvolatile memory can take a form other than a flash memory, such as a phase-change random access memory (PRAM).

The foregoing is illustrative of embodiments and is not to be construed as limiting thereof Although a few embodiments have been described, those skilled in the art will readily appreciate that many modifications are possible in the embodiments without materially departing from the novel teachings and advantages of the inventive concept. Accordingly, all such modifications are intended to be included within the scope of the inventive concept as defined in the claims.

What is claimed is:

1. A multiprocessor system comprising:
a multi-port semiconductor memory device comprising a mailbox area and a shared memory area accessible through a plurality of ports;
a first processor configured to write a multi-command set comprising multiple commands for multiple read/write operations to a command area of the shared memory, and to write a message to the mailbox area to indicate the writing of the multi-command set; and
a memory link architecture comprising a second processor connected to the multi-port semiconductor memory device, and a nonvolatile semiconductor memory device connected to the second processor, wherein the second processor is configured to read the multi-command set from the mailbox area and to sequentially perform the multiple read/write operations according to the multi-command set.

2. The multiprocessor system of claim 1, wherein the nonvolatile semiconductor memory device is connected to the multi-port semiconductor memory device through the second processor and comprises a flash memory for storing data written in the shared memory area by the first processor.

3. The multiprocessor system of claim 2, wherein each of the multiple commands comprises a command type, an address in the shared memory area, an address in the flash memory, and a sector counter.

4. The multiprocessor system of claim 2, wherein the message written to the mailbox area comprises a command type, a function code, and a function parameter.

5. The multiprocessor system of claim 2, wherein the first processor comprises a host processor and the second processor comprises an application specific integrated circuit (ASIC) processor.

6. The multiprocessor system of claim 2, wherein, the second processor performs an instant operation between execution of two of the multiple read/write operations in response to an instant command received during execution of one of the multiple read/write operations.

7. The multiprocessor system of claim 6, wherein the instant command is stored in the shared memory area.

8. The multiprocessor system of claim 6, wherein, after completing the instant data process operation, the second processor continues performing the remaining read/write operations of the multiple read/write operations.

9. The multiprocessor system of claim 1, wherein the multi-port semiconductor memory device comprises a OneDRAM.

10. The multiprocessor system of claim 1, wherein the multi-port semiconductor memory device further comprises a semaphore area configured to store information for controlling access to the shared memory area.

11. A multiprocessor system comprising:
a multi-port semiconductor memory device comprising dedicated memory areas and a shared memory area accessible through a plurality of ports, first and second mailbox areas configured to facilitate inter-processor communication, and a semaphore area configured to store information for controlling access to the shared memory area;
a first processor connected to a first port of the multi-port semiconductor memory device and configured to access a nonvolatile semiconductor memory device through the multi-port semiconductor memory device, to write a multi-command set or an instant command to a command area of the shared memory area, and to write a multi-command write message or an instant operation message to the second mailbox area; and
a second processor connected to a second port of the multi-port semiconductor memory device and to the nonvolatile semiconductor memory device to form a memory link architecture, and configured to read the multi-command set from the second mailbox area, to sequentially perform multiple read/write operations according to the multi-command set, and to perform an instant operation according to the instant command between two of the multiple read/write operations,
wherein the nonvolatile semiconductor memory device is configured to store data from the first and second processors.

12. The multiprocessor system of claim 11, wherein, after completing the instant operation, the second processor continues to perform remaining read/write operations among the multiple read/write operations.

13. The multiprocessor system of claim 11, wherein, after completing the instant operation, the second processor writes a process completion message to the first mailbox area.

14. The multiprocessor system of claim 11, wherein the multi-command write message comprises a command type, a function code, and a function parameter.

15. The multiprocessor system of claim 11, wherein the nonvolatile semiconductor device comprises a phase change random access memory (PRAM).

16. The multiprocessor system of claim 11, wherein the second processor comprises a media processor.

17. A method of operating a multiprocessor system comprising first and second processors, a multi-port semiconductor memory device connected to the first and second processors and comprising a shared memory area comprising a mailbox area and a command area, and a nonvolatile memory device connected to the second processor, the method comprising:
transmitting a multi-command set comprising multiple read/write commands from the first processor to the command area of shared memory area in the multi-port semiconductor memory device;
storing message data in the mailbox area to indicate the presence of the multi-command set in the command area;
detecting the message data in the mailbox area; and
as a consequence of detecting the message data in the mailbox area, accessing the multi-command set in the command area and operating the second processor to execute multiple read/write operations corresponding to the multiple read/write commands.

18. The method of claim 17, further comprising:
receiving an instant command in the shared memory during execution of one of the multiple read/write operations, and storing an instant command message in the shared memory area to indicate the presence of the instant command;
detecting the instant command stored in the shared memory based on the stored instant command message; and
operating the second processor to execute an operation defined by the instant command between execution of two of the multiple read/write operations.

19. The method of claim 17, wherein the first processor comprises a host processor and the second processor comprises an application specific integrated circuit (ASIC) processor.

20. The method of claim 17, wherein the nonvolatile memory comprises a NOR flash memory.
